(19) United States
(12) Patent Application Publication
(10) Pub. No.: US 2014/0067840 A1
(43) Pub. Date: Mar. 6, 2014

(54) SYSTEM AND METHOD FOR RETRIEVING INFORMATION

(71) Applicant: Tobias Brandstetter, Munich (DE)

(72) Inventor: Tobias Brandstetter, Munich (DE)

(21) Appl. No.: 13/965,994

(22) Filed: Aug. 13, 2013

(30) Foreign Application Priority Data
Aug. 30, 2012 (IE) S2012/0380

(51) Int. Cl. G06F 17/30

(52) U.S. Cl. CPC G06F 17/30516
USPC 707/758

(57) ABSTRACT

A system for retrieving information includes at least one database (120) storing a plurality of first content streams (50, 60, 70), each content stream (50, 60, 70) having at least one first search criterion assigned thereto. A content stream generating unit (101) for receiving a request to generate at least one second content stream (50, 60, 70), the request including at least one second search criterion. A comparing unit (102) for comparing the second search criterion to the plurality of first search criteria, an identifying unit (103) for identifying at least one first search criterion matching the second search criterion, and a subscribing unit (104) for subscribing the second content stream (50, 60, 70) to the first content stream (50, 60, 70) assigned to the matching first search criterion.

### BACKGROUND

The present invention relates to a system and method for retrieving information.

Social software platforms, for enabling networking between users, are well known. Twitter, for example is an online social network service and micro-blogging service that enables its users to send (post) and read text-based messages. Usually, a plurality of respective text based messages form a content stream (e.g. a blog).

With all of the known social network services, it is very problematic to find the information that is relevant for a particular user. Finding this relevant information might require downloading, searching, organizing and storing a massive amount of data. In Twitter, users select certain other users, whom they would like to follow. After selecting a respective user, the content or content posts generated by this user are forwarded to the user that has chosen to follow/subscribe to the other user. Accordingly, the content is filtered based on the author. Even with this filter mechanism, the information received is difficult to handle (e.g. organise, store, review, download). Also, it might be difficult to find an author who provides content that is interesting to another user. Additionally, the quality of one author's messages might vary depending upon the field, which the message is addressing. Generally, it is a problem to rate (quality, reliability, level of interest, etc.) content provided within digital networks, in particular within the internet.

Known search engines try to index all available content. However, it should be obvious that this requires a massive amount of processing power, storage and time.

Accordingly, there is a need for effectively channelling, organizing, forwarding and searching content present within the digital world.

### SUMMARY

In view of the abovementioned problems (e.g. efficiency, storage consumption, required calculation power, bandwidth), it is an objective of the present invention to provide a system and a method for efficiently retrieving information.

The problem is solved by a system in accordance with claim 1, as well as by a method in accordance with claim 8.

In particular, the problem is solved by a system for retrieving information, the system comprising:
at least one database storing a plurality of first content streams, each content stream having at least one first search criterion assigned thereto;
a content stream generating unit for receiving a request to generate at least one second content stream, the request comprising at least one second search criterion;
a comparing unit for comparing the second search criterion to the plurality of first search criteria;
an identifying unit for identifying at least one first search criterion matching the second search criterion;
a subscribing unit for subscribing the second content stream to the first content stream assigned to the matching first search criterion.

The inventive system can store a plurality of first content streams, each content stream having possibly a plurality of content posts as well as a first search criterion. The search criterion can be content related (e.g. the content post contains the word “clothes” or the content post relates to the field of fashion). The system requires the entering of a second search criterion as soon as a second content stream is generated. A comparing unit compares the second search criterion to the plurality of already (previously) stored first search criteria, whereby at least one first search criterion is found that matches the second search criterion. After locating a match, a subscribing unit can subscribe the second content stream to the first content stream that the matching first search criterion assigned thereto.

Accordingly, with the creation of a new content stream, an automatic subscription to another content stream already existing can be triggered. Alternatively, the user might be able to interact, e.g. select one content stream of a plurality of content streams or decline making a particular subscription. In accordance with the invention, a relevant content stream might not be found by means of searching the content of a particular content stream or a known user, but by identifying a search criterion assigned to a particular content stream that matches a second search criterion. Of course, there might be situations where no matching criterion is found. Accordingly, the user might be enabled to change the second search criterion, select an alternative matching algorithm and/or create the new content stream without subscribing to an already existing first content stream.

By using the mechanism of subscribing, a content stream might change with new content posts arriving. However, content posts contained in a particular content stream might not change, regardless of the modification of the provided search criterion. E.g., the past content will be static. This can be achieved by an appropriate database design. Also, once a search criterion is stored, information will be retrieved automatically such that the retrieval is more efficient. It might not be necessary to gather and process a huge amount of data since the subscription technique allows an immediate processing, thus distributing, of content posts.

According to another aspect of the present invention, a content post unit can be adapted to:
receive a content post for an origin content stream;
store the content post in at least one database;
store a first relation in at least one database, the first relation assigning the content post to the origin content stream;
identify at least one subscribed content stream, the subscribed content stream being subscribed to the origin content stream; and
store at least one second relation in at least one database, the second relation assigning content post to the subscribed content stream.

With the content post unit, it is possible that content posts are added to existing content streams. In the inventive system, respective content posts are assigned to the origin content stream, e.g. the content stream of the user creating the content post, and to at least one subscribed content stream. For example, the system can check for all of the content streams that have subscribed to the original content stream and assign the content post to those content streams. The assignment could be message based, e.g. similar to an email directed to a particular post box, or based on a link, e.g. the content stream is linked in the subscribed content stream. With a relational database, the link could be a 1−n relation. With the latter approach, storage space is saved—since the content post will not be duplicated, regardless of the number of subscribers.

According to another aspect of the present invention, the system might comprise a modification unit, the modification unit being adapted to:
receive a modification request for a content stream to be modified, the modification request comprising at least one new search criterion;
trigger the comparing unit to compare the new search criterion to the plurality of first search criteria;
trigger the identifying unit to identify at least one new first search criterion matching the new search criterion; and
trigger the subscribing unit to subscribe the content stream to be modified to the first content stream assigned to the matching new first search criterion.

It might be possible to amend existing content streams by providing a new or additional search criterion. A respective search criterion might be broader or narrower. A new search criterion could also be an alternative to the previous search criterion. Furthermore, a user could provide additional search criteria, which are narrower or broader or directed to a quite different subject matter. For example, one content stream might have several search criteria assigned thereto whereby each criterion might comprise logical conjunctions like “AND”, “OR” or “NOT”. The criteria can be linked to each other by logical conjunctions, e.g. by those mentioned before.

The change of a particular search criterion of a particular content stream might result in new matching search criteria such that the modified content stream can be subscribed to a new set or a different set of content streams. It is possible that the change of a search criterion will change the content (e.g. the posts) of a content stream. Preferably, the previous existing content stream stays unamended such that the gathered information is still available after the modification.

According to another aspect, the system might comprise a user database, when each content stream is assigned to and/or owned by at least one, in particular exactly one user.

The system might comprise an information unit adapted to:
receive a request from a first user;
select a/the origin content stream assigned to the first user;
select at least one subscribed content stream being subscribed to the origin content stream;
displaying a list of the at least one selected subscribed content stream and/or second user is assigned the at least one selected subscribed content stream.

Accordingly, it is possible that a first user receives a list showing all or a subset of the content streams that are subscribed to a particular content stream, e.g. owned by the user.

The information unit can be adapted to enable the first user to select at least one subscribed content stream from the list and to subscribe to the subscribed content stream. Accordingly, it is possible that a neutral relation between two content streams exists whereby content posts of either of the content streams are available to the other content stream. Accordingly, the system facilitates the finding of relevant information.

In one embodiment of the information unit, the content streams of interest are displayed independently of their subscription status. Accordingly, a particular user might see a list of content streams to subscribe to, regardless, whether or not he has subscribed to any of these content streams. The respective list might be generated upon request and/or upon a particular event (e.g. login of the user). A respective list could be generated by matching the search criterion and/or criteria of a particular user with the criteria of all or a subset of the existing content streams. As already mentioned, a respective list could comprise the names or any other indication of the available content streams. Additionally or as an alternative, the list might comprise the users having created the content streams. Additionally, a respective list could comprise status information of each content stream and/or user (e.g. about the subscription status, the creation of the respective content stream, and/or the last update time of the respective content stream).

The system might comprise a filtering unit being adapted to filter content streams in accordance with parameters assigned to the content streams. Such parameters could be time related parameters, content related parameters and/or geographical parameters. Preferably, the filtering unit applies a filter whereby a subset of the identified content streams is used by the subscribing unit.

The above-given problem is also solved by a method for retrieving information from a plurality of first content streams, in particular by using a system as previously described. Preferably, the first content streams each have at least one first search criterion assigned thereto. The method might comprise the following steps:
a) creating at least one second content stream;
b) assigning at least one second search criterion to the at least one second content stream;
c) comparing the at least one second search criterion with the plurality of first search criteria;
d) identifying at least one matching first search criterion of the plurality of first search criteria;
e) subscribing the second content stream to the first content stream assigned with the matching second search criterion.

This method has the same or similar positive effects as previously described.

In particular, the method enables a user to efficiently find and build up content streams containing relevant information.

The method might comprise the step of adding at least one content post to an origin content stream whereby the step of adding comprises:
receiving a content post for the origin content stream;
storing the content post in at least one database;
storing a first relation in at least one database, the first relation assigning the content post to the origin content stream;
identifying at least one subscribed content stream, the subscribed content stream being subscribed to the origin content stream;
storing at least one second relation in at least one database, the second relation assigning the content post to the subscribed content stream.

Accordingly, it is very simple and efficient to add content posts to the content streams. Content posts added to an origin content stream will be available in the content stream subscribed to the origin content stream. In accordance with the invention, relations might be stored such that the content of the content streams are stored very efficiently and automatically deduplicated.

The method might comprise a step of modifying a content stream by:
receiving a modification request for the content stream to be modified, the modification request comprising at least one new search criterion;
comparing the new search criterion to the plurality of first search criterion;
identifying at least one new first search criterion matching the new search criterion; and
subscribing the content stream to be modified to the first content stream assigned to the matching new first search criterion.

Thus, modifying a content stream might lead to a modification of the content of the content stream (e.g. content posts). However, in a preferred embodiment, the previous content posts will remain unamended such that previous posts will be available even after modification.

The method might comprise the method steps of authenticating at least one user and assigning the at least one second content stream to the user, in particular in the role of an owner of the second content stream. Preferably, each content stream has at least one user assigned thereto. Even more preferably, there is an owner—a particular user—of a content stream. The owner of a content stream might be responsible for the content of the content stream as well as for the management of the respective content stream.

The method might comprise the step of informing an owner of the first content stream about the subscribing of the second content stream to the first content stream assigned with the matching second search criterion. Respective information might be displayed within a webpage and/or provided within a message sent to the user. In response to the provision of respective information, the owner might request to subscribe the first content stream to the second content stream.

The step of identifying at least one matching search criterion of the plurality of first search criteria might result in a plurality of matching search criteria whereby a plurality of content streams are assigned to the respective first search criteria. Accordingly, the method might perform a filtering of the plurality of first content streams. The filtering might address parameters assigned to the first content streams, e.g. with respect to the creation time of the content stream, as update of the content stream, creator of the content stream, geographical information related to the content stream and/or update frequency of the content stream.

The above-given problem is also solved by a computer readable medium having computer executable instructions adapted to cause the computer system to perform the method as previously described.

These and other aspects of the invention will be apparent from and elucidated with reference to the embodiment described herein after.

### BRIEF DESCRIPTION OF THE DRAWINGS

FIG. 1 shows a web server and a plurality of client computers connected to each other and to the web server though the internet;

FIG. 2 shows a schematical view of components of the web server;

FIG. 3 illustrates the content of a content stream;

FIG. 4 shows an exemplary database scheme for implementation of the present invention;

FIG. 5 shows an exemplary activity diagram illustrating the creation of a content stream in accordance with the present invention; and

FIG. 6 shows an exemplary social graph created by the inventive system.

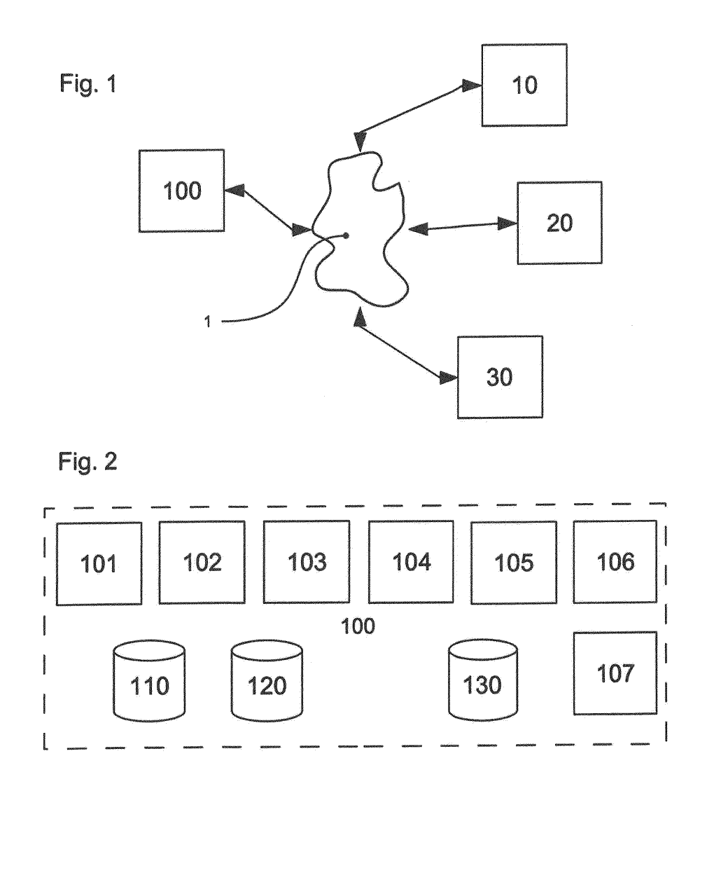

### DETAILED DESCRIPTION

In accordance with the present invention, a web server 100 (e.g. called Favesync server) is connected to a plurality of client computers 10, 20, 30 by means of the internet 1. Of course, the web server 100 could be connected to the client computers 10, 20, 30 by various types of networks, e.g. by a LAN or WAN.

Logically, one embodiment of the web server 100 comprises the following components:
content stream generating unit 100;
comparing unit 102;
identifying unit 103;
subscribing unit 104;
content post unit 105;
modification unit 106; and
information unit 107.

All of these units might communicate with each other to implement the functionality as described herein. Additionally, the web server 100 might comprise databases for storing data, in particular a user database 110, a content database 120, a profile database 130. It is the objective of the inventive system to retrieve information from content streams.

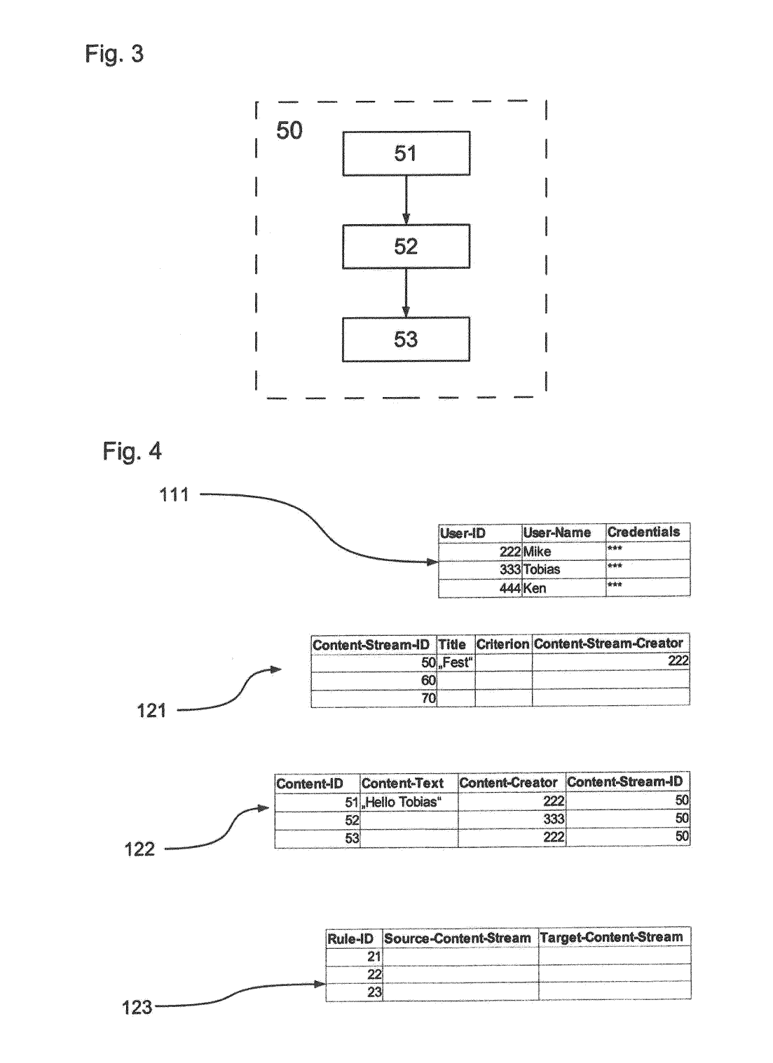

An exemplary content stream 50 is shown in FIG. 3. A content stream 50 might comprise several content posts 51, 52, 53 whereby each content post could e.g. be a text message. Usually, a content stream 50 is organised such that the content posts 51, 52, 53 have a sorting order. In the embodiment described herein, the content stream 50 is organised by time stamps whereby each content post 51, 52, 53 has a time stamp assigned thereto such that the content stream 50 can represent a conversation of several users over time. In addition to the time stamp, each of the content posts 51 and/or the content stream 50 can comprise additional properties, e.g. creator of a content post, creator of a content stream, creation time of a content stream and/or others.

Also, it might be possible that a user adds a “subpost” to a particular content post 51, 52, 53. Accordingly, a content stream 50 might have several branches of content posts 51, 52, 53.

Referring to FIG. 4 an exemplary implementation of the content stream 50 is described. The necessary data might be organised in a content stream table 121 and a content table 122, whereby both of these tables 121, 122 could be maintained within the content database 120.

The content stream table 121 might comprise the following columns:
Content-Stream-ID;
Title;
Criterion;
Content-Stream-Creator.

Each row within the content stream table 121 might correspond to a content stream 50, 60, 70 assigning a content stream ID, a title, a criterion and a content-stream-creator to a particular content stream 50, 60, 70. In the given example, the first row of the content stream table 121 indicates that the stream has the content-stream-ID 50 and that the content-stream-creator with the user-ID 222 has created the content stream. Rows 2 and 3 contain further information for a second content stream 60 and a third content stream 70.

The content table 122 might contain the following columns:
Content-ID;
Content-Text;
Content-Creator;
Content-Stream-ID.

In the content table 122, each row might correspond to a content post 51, 52, 53. In the given example, the three content posts 51, 52, 53 are stored within the content table 122, whereby the content posts 51, 52, 53 have the content-ID 51, 52, 53. Each of these content posts 51, 52, 53 are related to the content stream 50 with the content-stream-ID 50. In the first line, data regarding the content post 51 is stored, whereby the content text is “Hello Tobias” and the content creator refers to the user ID 222.

The column's content-stream-creators and content-stream-ID might refer to a user table 111 stored within the user database 110. The user table 111 might comprise a user-ID, a user name and credential. In the exemplary embodiments shown in FIG. 4 the three rows of the user table 111 correspond to three users with the names “Mike”, “Tobias” and “Ken” having the user-ID 220, 333, 444 respectively. Credentials are also stored in the user table 111 to allow authentication of the respective users.

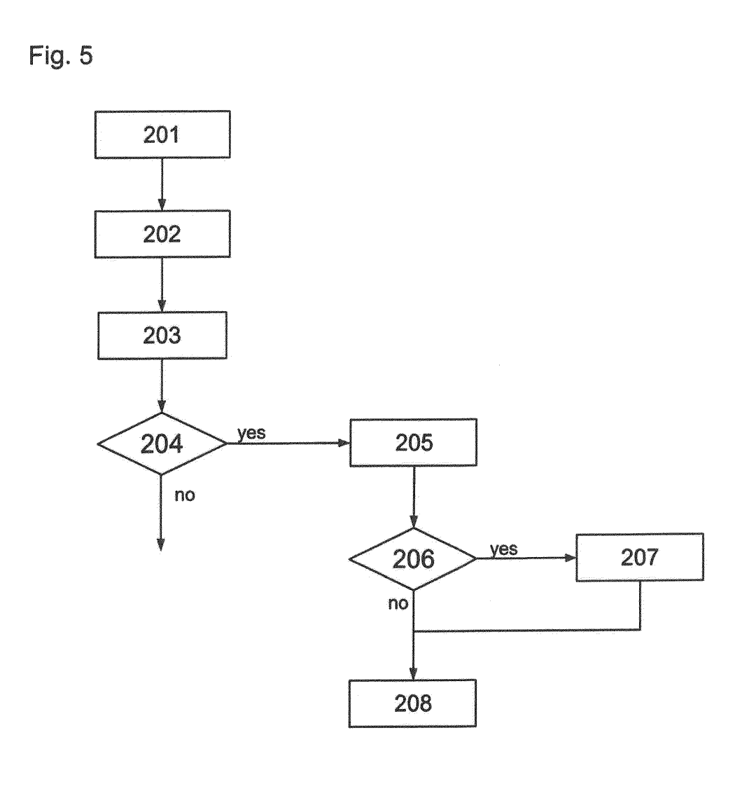

Turning to FIG. 5, the inventive system is described in more detail. In one embodiment a user, e.g. the user “Mike” might want to create a new content stream 50. For doing so, the user accesses the content stream generation unit 101 and enters a name for the content stream (step 201 of FIG. 5). In the given embodiment, the user Mike might enter the title “test”. After having entered the title of the content stream, the content stream generation unit 101 might request the user to enter a search criterion (step 202 of FIG. 5). After having received the search criterion the content stream generation unit 101 might store a respective row within the content stream table 121.

In a next step, the comparing unit 102 and the identifying unit 103 might identify an already existing content stream 60 which matches the search criterion entered in step 202. In FIG. 5, the method step 204 symbolises the matching of criteria. In case there is no matching, such criteria—accordingly, there is no matching content stream—the creation process of the content stream 50 might end. In a further step, a user of the content stream 50 might add content posts 51, 52, 53 to the content stream 50. In case there is a set of search criterion matching the entered search criterion of step 202, the user will be displayed a list of content streams 60, 70 associated with the matching search criteria (step 205 of FIG. 5). If the user decides in step 206 to subscribe to one of the matching content streams, a respective subscription rule is generated in step 206 and stored in a rule table 123 (step 207). The subscribing unit 104 and/or the identifying unit 103 might be responsible for generating the list of matching content streams 60, 70. The subscriber unit 104 will perform the necessary steps for subscribing the content stream 50 to the selected matching content stream 60 or 70.

After subscribing to a particular content stream 60 or 70, the information unit 107 might inform the owner of that content stream 60 or 70 about the new subscription. The inventive system might enable the respective user to subscribe the already existing content stream 60 or 70 to the created content stream 50.

Following up, the term fellow will be used for the relationship between two users having content streams 50, 60, 70 with matching criteria. The relationship between fellows can be further specified by the subscription status of their content streams, e.g. synchronised or not synchronised. The term passive fellow refers to a user that receives content posts 51, 52, 53 from another user only. An active fellow will be a user who receives and provides content posts 51, 52, 53 to and from another user. Following up the term Fave might be used as a substitute for a content stream, e.g. the content streams 50, 60, 70. In accordance with the present invention, a user can open a Fave by

defining search criteria and storing these. With the opening of the respective content stream 50, 60, 70, the search criterion will be compared to other search criteria of other users. Up to the closing or deletion of the content stream 50, 60, 70 related content streams will be synchronised.

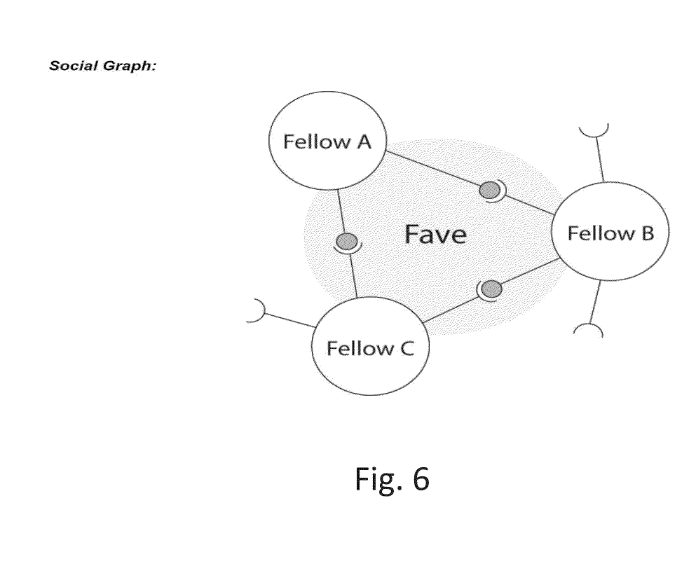

FIG. 6 illustrates a social graph created by the inventive system.

A Fave and/or content stream can be considered as a meta group providing individualised views on context after having stored a particular search term. A “broader” Fave/content stream (e.g., content contains “cat”) might return more tangible (“narrower”) Fave (e.g. content contains “street cat”).

The inventive system might be used to select a plurality of fellows based on a first search criteria. Afterwards, a user might reduce the selection by introducing further search criteria narrowing down the scope of a particular content stream. Also, it could be possible to broaden the scope of a content stream 50, 60, 70 by adding additional search criteria. For example, a user might first specify the search criteria that the context contains the word “cat” and then add that the context contains the word cat or the word dog.

Also, the inventive system might implement filters to reduce the number of content streams 50, 60, 70 and/or content posts 51, 52, 53 displayed to and/or exchange between users by applying filters, e.g. based on time stamps and/or location information. For example, a user located in Germany might be only interested in content streams 50, 60, 70 created by another user within the European Union. Also, content streams 50, 60, 70 which have not been updated for years might not be relevant to a particular user.

Additionally, the system might implement a mechanism to switch the status of a content stream 50, 60, 70 between open and closed. An open content stream 50, 60, 70 will be matched with every new content stream created. Accordingly, the number of fellows might increase. A closed content stream 50, 60, 70 is not available for new matchings. Accordingly, the fellows of a particular content stream will remain constant. Nevertheless, content posts 51, 52, 53 will be exchanged between the existing fellows although the content stream is in a closed status.

As it will be obvious to the person skilled in the art, the above-described features can be combined in numerous ways resulting in numerous different systems and/or methods.

Thus, the invention provides, among other things, a {text}. Various features and advantages of the invention are set forth in the following claims.

1. A system for retrieving information, comprising:
at least one database (120) storing a plurality of first content streams (50, 60, 70), each content stream (50, 60, 70) having at least one first search criterion assigned thereto;
a content stream generating unit (101) for receiving a request to generate at least one second content stream (50, 60, 70), the request comprising at least one second search criterion;
a comparing unit (102) for comparing the second search criterion to the plurality of first search criteria;
an identifying unit (103) for identifying at least one first search criterion matching the second search criterion;
a subscribing unit (104) for subscribing the second content stream (50, 60, 70) to the first content stream (50, 60, 70) assigned to the matching first search criterion.

2. The system of claim 1, characterized by:
a content post unit (105) being adapted to:
receive a content post (51, 52, 53) for an origin content stream (50, 60, 70);
store the content post in at least one database (120);
store a first relation in at least one database (120), the first relation assigning the content post (51, 52, 53) to the origin content stream (50, 60, 70);
identify at least one subscribed content stream (50,60, 70), the subscribed content stream (50, 60, 70) being subscribed to the origin content stream (50, 60, 70);
store at least one second relation in at least one database (120), the second relation assigning the content post (51, 52, 53) of the origin content stream (50, 60, 70) to the subscribed content stream (50, 60, 70).

3. The system of claim 1, characterized by:
a modification unit (106) being adapted to:
receive a modification request for a content stream (50, 60, 70) to be modified, the modification request comprising at least one new search criterion;
trigger the comparing unit to compare the new search criterion to the plurality of first search criteria;
trigger the identifying unit to identify at least one new first search criterion matching the new search criterion; and
trigger the subscribing unit to subscribe the content stream (50, 60, 70) to be modified to the first content stream (50, 60, 70) assigned to the matching new first search criterion.

4. The system of claim 1, characterized by a user database (110), wherein each content stream (50, 60, 70) is assigned to and owned by exactly one user.

5. The system of claim 1, characterized by:
an information unit adapted to
receive a request from a first user;
select an origin content stream (50, 60, 70) assigned to the first user;
select at least one subscribed content stream (50, 60, 70) being subscribed to the origin content stream (50, 60, 70);
displaying a list of the at least one selected subscribed content stream (50, 60, 70) and/or second users assigned the at least one selected subscribed content stream (50, 60, 70).

6. The system of claim 5, characterized in that the information unit (107) is adapted to enable the first user to select at least one subscribed content stream (50, 60, 70) from the list and to subscribe to the subscribed content stream (50, 60, 70).

7. The system of claim 1, characterized by a filtering unit being adapted to filter content streams (50, 60, 70) in accordance with parameters assigned to the content streams (50, 60, 70), wherein at least one of the subscribing unit (104) and the identifying unit (103) is adapted to use an output of the filtering unit.

8. A method for retrieving information from a plurality of first content streams (50, 60, 70) using a system according to claim 1, the first content streams (50, 60, 70) each having at least one first search criterion assigned thereto, the method comprising:
a) creating at least one second content stream (50, 60, 70);
b) assigning at least one second search criterion to the at least one second content stream (50, 60, 70);
c) comparing the at least one second search criterion with the plurality of first search criteria;
d) identifying at least one matching first search criterion of the plurality of first search criteria;
e) subscribing the second content stream (50, 60, 70) to the first content stream (50, 60, 70) assigned with the matching second search criterion.

9. The method of claim 8, characterized by:
f) adding at least one content post (51, 52, 53) to an origin content stream (50, 60, 70), the step of adding comprising:
receiving a content post (51, 52, 53) for the origin content stream (50, 60, 70);
storing the content post in at least one database (120);
storing a first relation in at least one database (120), the first relation assigning the content post (51, 52, 53) to the origin content stream (50, 60, 70);
identifying at least one subscribed content stream (50, 60, 70), the subscribed content stream being subscribed to the origin content stream (50, 60, 70);
storing at least one second relation in at least one database (120), the second relation assigning the content post (51, 52, 53) to the subscribed content stream (50, 60, 70).

10. The method of claim 9, characterized by a step of:
g) modifying a content stream (50, 60, 70) by:
receiving a modification request for the content stream (50, 60, 70) to be modified, the modification request comprising at least one new search criterion;
comparing the new search criterion to the plurality of first search criteria;
identifying at least one new first search criterion matching the new search criterion;
subscribing the content stream (50, 60, 70) to be modified to the first content stream (50, 60, 70) assigned to the matching new first search criterion.

11. The method of claim 10, characterized by
h) authenticating at least one user; and
i) assigning the at least one second content stream (50, 60, 70) to the user, in particular in the role of an owner of the second content stream (50, 60, 70).

12. The method of claim 11, characterized by
j) informing an owner of the first content stream (50, 60, 70) about the subscribing of the second content stream (50, 60, 70) to the first content stream (50, 60, 70) assigned with the matching second search criterion, and
k) receiving a request from the owner to subscribe the first content stream (50, 60, 70) to the second content stream (50, 60, 70).

13. The method of claim 8, characterized in that step
d) comprises identifying a set of first content streams (50, 60, 70) having matching criteria.

14. A computer-readable medium having computer executable instructions adapted to cause the computer to perform the method of claim 8.

15. The system of claim 7, wherein the parameters assigned to the content streams (50, 60, 70) includes at least one of creation time of the content stream (50, 60, 70), last update of the content stream (50, 60, 70), creator of the content stream, geographical information related to the content stream (50, 60, 70), and update frequency of the content stream (50, 60, 70).

16. The method of claim 8, characterized by a step of:
f) modifying a content stream (50, 60, 70) by:
receiving a modification request for the content stream (50, 60, 70) to be modified, the modification request comprising at least one new search criterion;
comparing the new search criterion to the plurality of first search criteria;
identifying at least one new first search criterion matching the new search criterion;
subscribing the content stream (50, 60, 70) to be modified to the first content stream (50, 60, 70) assigned to the matching new first search criterion.

17. The method of claim 8, characterized by
f) authenticating at least one user; and
g) assigning the at least one second content stream (50, 60, 70) to the user, in particular in the role of an owner of the second content stream (50, 60, 70).

18. The method of claim 8, characterized by
f) informing an owner of the first content stream (50, 60, 70) about the subscribing of the second content stream (50, 60, 70) to the first content stream (50, 60, 70) assigned with the matching second search criterion, and
g) receiving a request from the owner to subscribe the first content stream (50, 60, 70) to the second content stream (50, 60, 70).

19. The method of claim 13, wherein the set of first content streams (50, 60, 70) is filtered with respect to parameters assigned to the first content streams (50, 60, 70), the parameters selected from one of the creation time of the content stream (50, 60, 70), the last update of the content stream (50, 60, 70), the creator of the content stream (50, 60, 70), the geographical information related to the content stream (50, 60, 70), and the update frequency of the content stream (50, 60, 70).

20. The method of claim 12, wherein the step of informing the owner of the first content stream (50, 60, 70) about the subscribing of the second content stream (50, 60, 70) to the first content stream (50, 60, 70) is performed at least partially by generating at least one of a list and a message.
